(19) United States
(12) Patent Application Publication
(10) Pub. No.: US 2025/0187223 A1
(43) Pub. Date: Jun. 12, 2025

(54) Bread slicer

(71) Applicant: JAC S.A., Liège (BE)

(72) Inventor: Baudouin Van Cauwenberghe, Liège (BE)

(21) Appl. No.: 18/653,020

(22) Filed: May 2, 2024

(30) Foreign Application Priority Data
May 2, 2023 (BE) 2023/5354

(51) Int. Cl. B26D 7/32; B26D 1/157; B26D 7/06; B65B 5/04; B65B 25/18; B65B 43/54

(52) U.S. Cl. CPC B26D 7/32; B26D 7/0608; B65B 5/045; B65B 25/18; B65B 43/54; B26D 1/157; B26D 2007/327; B26D 2210/06

(57) ABSTRACT

A bread slicer having a frame includes a loading compartment at the front of the frame and a receiving compartment connected to the loading compartment at the rear side of the frame, an access opening for the bread in the loading compartment, a cutting member to cut slices of the bread as it moves between the compartments, a support surface for the bread extending into the compartments, a movable push rod moveable in the direction of movement of the bread enabling the bread to be seized and moved between the compartments, the push rod being guided by a guide rail extending substantially parallel to the support surface and to the direction of movement. The support surface is inclined at an angle (α) greater than 10° and less than 25°, in particular between 15° and 24°, with respect to a horizontal line extending perpendicularly to the front side of the slicer.

The invention relates to a bread slicer with a frame having a front side opposite a rear side and two lateral sides extending between the front side and the rear side. This slicer is designed to be used by a user who is positioned at the front side of the machine. The slicer comprises:
a loading compartment which is connected to a receiving compartment; the loading compartment is adjacent to the front side and the receiving compartment is close to the rear side of the slicer frame,
an access opening for the loading compartment to put a loaf of bread to be sliced in this compartment; the access opening is accessible from said front side by a user who is positioned in front of this front side to put a loaf of bread to be sliced in the loading compartment and to pick up the loaf of bread after it has been sliced,
a cutting member that can move along a cutting plane to cut slices of the bread as it is moved between said compartments,
a support surface for the bread extending into said compartments and having a slot between the compartments to allow the passage of the cutting member along said cutting plane; the support surface defines a direction of movement of the bread between the front side and the rear side of the frame which extends parallel to the support surface,
a movable push rod which can move in said direction of movement of the loaf, making it possible for the loaf to be seized and moved between said compartments across the cutting plane, this movable push rod being guided by a guide rail extending substantially parallel to the support surface and to said direction of movement.

Slicers with the above features are described, for example, in document EP 3 907 051. This document describes a slicer whose support surface for the loaf of bread to be sliced is inclined at a fairly large angle with respect to the horizontal direction.

This means that the bread must be moved over a relatively large vertical height against gravity after having been seized by the push rod as it moves from the loading compartment to the receiving compartment. As a result, the push rod's grips risk tearing the bread, causing it to slide downwards.

If the bread then must be lowered again to be sliced, it is necessary to slow down the downward movement of the bread using a drive motor that drives the push rod relative to the guide rail. In addition, the load exerted on this motor by the bread due to gravity decreases each time a slice of bread is cut in the bread slicer. This requires a relatively complex control system and a fairly large motor.

Thus, a steep slope of the support surface not only risks tearing the bread from the push rod, but requires overly large components including a stepper motor, a brake, a belt, pulleys, etc.

Further, it was also noted that it is important for the support surface to have a certain slope so that the slices of bread already cut do not press against the uncut part of the bread, which would be detrimental to the quality of the slices formed. In addition, a certain slope makes it easier to move the bread downwards during slicing without the bread encountering too much resistance from the surface as it moves.

It is also found that existing slicers are often too high, and the sliced bread has to be removed from the slicer at too low a level. This is, for example, detrimental to the ergonomics of the machine.

Consequently, the aim of the invention is to propose a slicer that is less complex and as compact as possible, also offering improved ergonomics.

To this end, according to the invention, the support surface is inclined at an angle (α) greater than 10° and less than 25°, in particular between 15° and 24°, with respect to a horizontal line which extends perpendicularly to the front side of the slicer.

Advantageously, said guide rail for the push rod extends laterally along at least part of the receiving compartment.

According to an often-applied embodiment of the invention, the slicer comprises a movable support that can be moved to support and/or push the bread to be sliced or the slices of the sliced bread.

According to a particular embodiment of the invention, the slicer according to the invention comprises a bagging pallet which is provided in the loading compartment. This pallet can be moved between a receiving position in which the pallet extends in the plane of the support surface and a wrapping position in which at least one end of the pallet is raised relative to the plane of the support surface.

According to an interesting embodiment of the invention, the bagging pallet is pivot-mounted about a pivot axis extending horizontally.

In an advantageous embodiment of the slicer according to the invention, the slicer has a lateral guide surface adjacent to the support surface. This guide surface extends substantially transversely with respect to the support surface and parallel to said direction of movement so as to guide the bread as it moves between the compartments.

According to a remarkably interesting embodiment of the slicer according to the invention, the support surface is inclined between said lateral sides with respect to the horizontal, so that a loaf of bread which is put on the support surface will rest against said guide surface.

Very advantageously, the bagging pallet has a lateral flange connecting to the guide surface in the pallet's receiving position.

The invention also relates to a method for automatically slicing a loaf of bread, making it possible to wrap the loaf after it has been sliced with a slicer having a frame with a front side, opposite a rear side, and two lateral sides extending between the front side and the rear side. This slicer comprises a loading compartment connected to a receiving compartment, and the loading compartment is adjacent to said front side while the receiving compartment is close to said rear side.

The method according to the invention comprises the following steps:
a loaf of bread to be sliced is put in the loading compartment of the slicer by a user who is positioned in front of the front side of the slicer,
the loaf is seized by means of a movable push rod which is guided by a guide rail,
the loaf is moved towards a receiving compartment by means of the push rod and returned to the loading compartment as of the receiving compartment in a direction of movement which is inclined to the horizontal and substantially parallel to said guide rail,
successive slices of the loaf are cut as it moves downwards in the direction of movement between the compartments, the slices being cut from the bread in a cutting plane extending substantially perpendicularly to said direction of movement of the bread.

This method is characterized in that the bread and the movable push rod are moved in said direction of movement inclined at an angle (α) greater than 10° and less than 25°, in particular between 15° and 24°, relative to a horizontal line which extends perpendicularly to the front side of the slicer.

According to a preferred embodiment of the method according to the invention, the bread is received by a bagging pallet following the movement of the bread from the receiving compartment to the loading compartment in said direction of movement. This pallet extends substantially in said direction of movement when receiving the bread.

In an interesting embodiment of the method according to the invention, said direction of movement of the bread is upwards when the bread is moved from the loading compartment to the receiving compartment. In an alternative embodiment, the direction of movement of the bread is downward when the bread is moved from the loading compartment to the receiving compartment.

Other details and particularities of the invention will become clear from the description given below, by way of a non-restrictive example, of some particular embodiments of the slicer and method according to the invention with reference to the appended drawings.

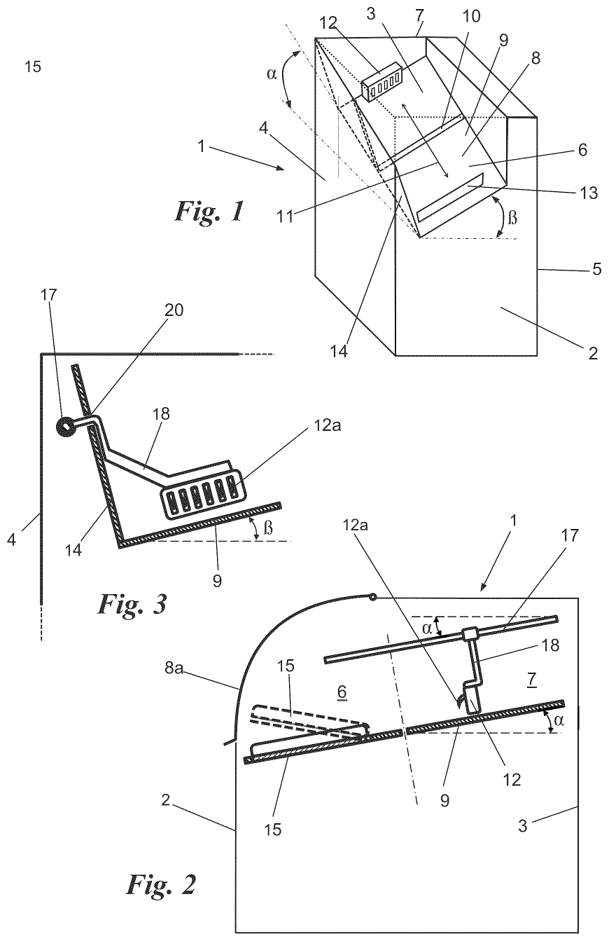

FIG. 1 is a very schematic perspective view of a bread slicer according to the invention.

FIG. 2 is a very schematic vertical section along a plane extending substantially transversely to the front and rear sides of the slicer according to the invention.

FIG. 3 is a very schematic vertical section, parallel to the front side, of a part of the slicer including the push rod.

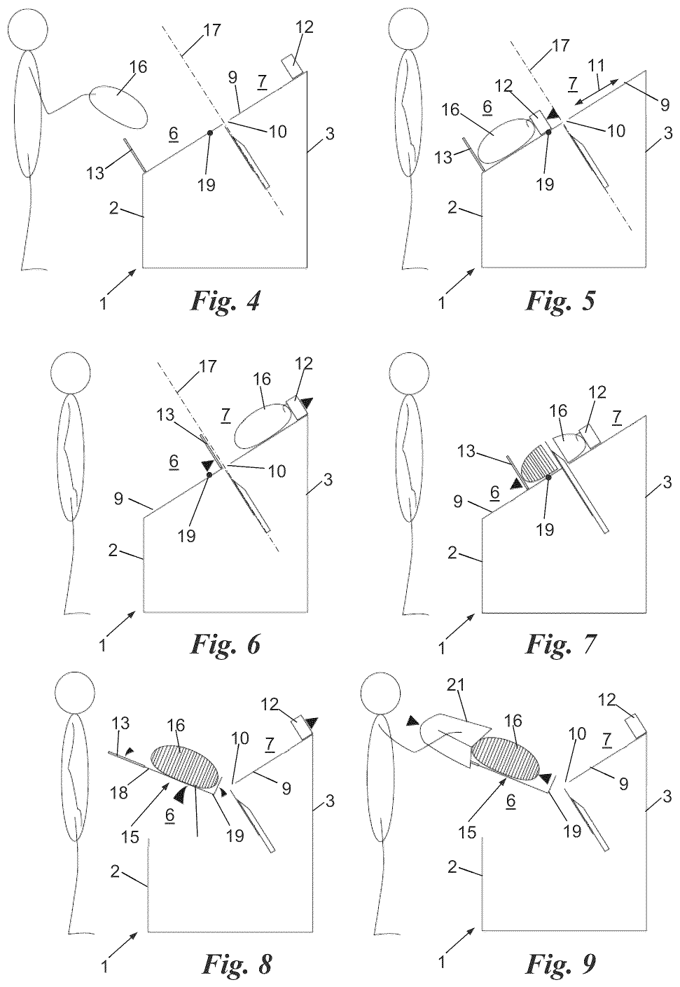

FIGS. 4 to 9 show a schematic side view of a bread slicer according to an interesting embodiment of the invention, illustrating distinct stages from the introduction of a loaf to be sliced up to the removal of the sliced loaf.

In the different figures, the same reference numbers refer to similar or identical elements.

In general, the invention relates to an automatic bread slicer that makes it easy to wrap a sliced loaf of bread. Such a slicer is shown very schematically in FIG. 1.

The slicer 1 has a rectangular base and comprises a frame with a front side 2 opposite a rear side 3 and two lateral sides 4 and 5 extending between the front side 2 and the rear side 3. The sides of the frame preferably each extend approximately in a straight and vertical plane. The front side 2 and the rear side 3 are, for example, perpendicular to the lateral sides 4 and 5.

Adjacent to the front side 2, the interior of the slicer 1 comprises a loading compartment 6 to put in a loaf of bread to be sliced and to retrieve the bread after it has been cut into slices. This loading compartment 6 is connected to a receiving compartment 7 which is provided in the slicer 1 near the rear side 3.

In order to be able to introduce a loaf of bread into the slicer and to retrieve this loaf after it has been sliced, an access opening 8 is provided which gives access to the loading compartment 6. For clarity's sake, this access opening is not shown in the figures, but only indicated by the reference number 8. The access opening is accessible from said front side 2 by a user who is positioned in front of this front side 2 to put a loaf of bread to be sliced in the loading compartment 2 and to retrieve the loaf after it has been sliced. This access opening 8 is therefore provided in the front side 2 and/or in the upper side of the slicer 1 facing the loading compartment 6. Preferably, this access opening 8 can be closed by a lid 8a, as shown in FIG. 2, during the operation of the slicer 1.

A support surface 9 for the bread extends into the two aforementioned compartments 6 and 7. The support surface 9 is relatively smooth and has no rough edges, so that a loaf of bread can slide easily over this surface. Optionally, this surface 9 may have a certain texture provided it does not make the surface rough or hinder the movement of the bread. This support surface 9 is made of stainless steel, for example.

Between these compartments 6 and 7, a slot 10 is provided in the support surface 9 to allow the passage of a cutting member along a cutting plane. The cutting member is designed to cut slices of bread and comprises, for example, a circular blade being driven about its axis. This cutting member, together with the circular blade, can be moved along a cutting plane through said slot 10. The cutting plane preferably extends perpendicularly to the support surface 9 between said compartments 6 and 7.

After the introduction of a loaf of bread to be sliced into the loading compartment 6, it is moved in a direction of movement, as indicated by the double arrow 11, towards the receiving compartment 7. This direction of movement 11 extends between the front side 2 and the rear side 3 of the chassis and parallel to the support surface 9.

Preferably, this direction of movement 11 of the bread is substantially parallel to a vertical plane which extends transversely with respect to said front side 2 and/or said rear side 3, or approximately parallel to the lateral sides 4 and 5 of the frame of the slicer 1.

The slicer also comprises a movable push rod 12 which can be moved along said direction of movement 11 of the bread to move the bread between said compartments 6 and 7 across the cutting plane. This push rod 12 is known to the person skilled in the art and comprises, for example, retractable grips 12a. A push rod with retractable grips is described, for example, in document DE 202011005113.

This push rod 12 cooperates with a mobile support 13 which can also be moved in said direction of movement 11 of the bread. Such a mobile support 13 is known to those skilled in the art and makes it possible to support the bread to be sliced or to support the slices cut from the bread. To this end, the mobile support 13 is driven in the direction of movement of the bread.

The push rod 12 and the mobile support 13 can, for example, be driven by means of a toothed belt extending along and next to the support surface 9, a is shown, for example, in EP 2045053.

In the slicer according to the invention, the support surface is inclined at an angle α with respect to a horizontal line extending perpendicular to the front side 2 of the slicer 1, as shown in FIG. 1. This angle α is between 10° and 25°, in particular between 15° and 24°. An angle α which is between 20° and 24° appears to offer the best result in terms of bread cutting quality and user ergonomics.

Optionally, the support surface 9 can also be inclined at an angle β with respect to a straight line extending transversely with respect to the lateral sides 4 and 5 of the slicer 1, as shown in FIG. 1. This angle β is, for example, between 15° and 45°.

In such a case, the slicer 1 has a lateral guide surface 14 which is adjacent to the support surface 9. This guide surface 14 extends substantially transversely with respect to the support surface 9 and parallel to said direction of movement 11 in order to help guide the bread as it moves between the compartments 6 and 7.

When a loaf of bread is put in the loading compartment 6 of a slicer having a support surface which is inclined at an angle α and an angle β, as shown in FIG. 1, the bread slides over the support surface 9 up against said guide surface 14 and, possibly, the movable support 13. The push rod 12 then approaches the loaf and the grips 12a of the push rod 12 are activated to seize the loaf on the side opposite the mobile support 13. The bread is then moved towards the receiving compartment 7 by the movement of the push rod 12 as it slides over the support surface 9 and against the guide surface 14.

FIG. 2 very schematically shows a slicer 1 according to the invention, having a loading compartment 6 and a receiving compartment 7 with a support surface 9 which is inclined at an angle α to the horizontal in the direction of movement of the bread 11.

In the loading compartment 6, part of the support surface 9 forms a bagging pallet 15 which can be moved into a wrapping position as of the plane of the support surface. For this purpose, the bagging pallet 15 can pivot about an axis 19. FIG. 2 shows the pallet 15 with a dotted line in the wrapping position.

The slicer 1 shown in FIG. 2 has a movable pusher 12 which can move in the direction of movement 11 and which can seize a loaf of bread 16 to be sliced by means of retractable grips 12a. After a loaf of bread has been put in the loading compartment 6, it is seized by the retractable grips 12a of the push rod 12. The loaf of bread 16 is then moved towards the receiving compartment 7 through the cutting plane 17 by the movement of the push rod 12. During this movement, the push rod 12 is guided by a guide rail 17 which extends substantially parallel to the support surface 9 and therefore parallel to the direction of movement 11.

The push rod 12 is connected by a support arm 18 to the guide rail 17 which can be moved over the rail 17 by means of a drive system not shown in the figures. This drive system may comprise, for example, an electric motor and possibly a drive belt.

FIG. 3 shows a very schematic section in a plane transverse to the direction of movement 11 of the loaf of bread 16. This figure shows a lateral guide surface 14 adjacent to the support surface 9 which extends substantially transversely with respect to the latter and parallel to the direction of movement 11. This lateral guide surface 14 delimits the compartments 6 and 7 and helps to guide the loaf of bread 16 as it moves between these compartments. At the level of the guide rail 17, this guide surface has a slot 20 for the passage of the support arm 18 of the push rod 12.

The guide rail 17 for the push rod 12 preferably extends outside the compartments 6 and 7. In particular, this rail 17 preferably extends laterally along at least part of the receiving compartment 7.

FIGS. 4 to 9 show another interesting embodiment of the slicer according to the invention. As shown in FIGS. 8 and 9, this slicer comprises a bagging pallet 15 which can be moved into a wrapping position to wrap the sliced bread. In this embodiment of the invention, the movable support 13 is moved together with the bagging pallet 15 after the bread has been sliced.

The bagging pallet 15 is mounted so that it can rotate about a fixed axis 19. This axis 19 extends into the loading compartment 6 and in the plane of the support surface 9.

When the bagging pallet 15 has reached the wrapping position, the movable support 13 is folded towards the user who is in front of the front side of the slicer and in line with the pallet 15. In this way, the user can slide a bag 21 over the mobile support 13, the pallet 15 and the loaf of bread 16 as a whole to retrieve the latter, as shown in FIG. 9.

In the above-described embodiments of the slicer according to the invention, the bagging pallet 15 is moved from its receiving position to the wrapping position by a rotation about an axis 19 provided near the cutting plane 17. Thus, the end of the loaf of bread 16 that is directed towards the front side 2, or towards the user, is moved upwards when the pallet is moved towards its wrapping position.

The bagging pallet 15 may comprise, for example, oblong recesses extending side by side. Thus, when a wrapping bag 21 is slid over the sliced bread and the pallet 15, this bag 21 can be slid along the recesses next to the loaf of bread 16. Thus, the size of the bag can be chosen according to the measurements of the loaf.

1. A bread slicer having a frame with a front side opposite a rear side and two lateral sides extending between the front side and the rear side, which slicer comprises:
a loading compartment which is connected to a receiving compartment, the loading compartment (6) being adjacent to said front side while the receiving compartment is close to said rear side,
an access opening (8) for the loading compartment to put a loaf of bread to be sliced in this compartment, the access opening being accessible from said front side by a user who is positioned in front of this front side to put a loaf of bread to be sliced in the loading compartment and to retrieve the loaf of bread after the loaf of bread has been cut into slices,
a cutting member which can move along a cutting plane to cut slices of the bread (16) as the cutting member moves between said compartments,
a support surface for the bread extending into the above-mentioned compartments and having a slot between the compartments to allow the passage of the cutting member along said cutting plane, this support surface defining a direction of movement of the bread extending between the front side and the rear side of the frame and parallel to the support surface,
a movable push rod which can move in said direction of movement (11) of the bread (16) which enables the bread to be seized and moved between said compartments through the cutting plane, this movable push rod being guided by a guide rail extending substantially parallel to the support surface and to said direction of movement,
wherein the support surface is inclined at an angle (α) greater than 10° and less than 25° with respect to a horizontal line extending perpendicularly to the front side of the slicer.

2. The slicer according to claim 1, wherein the guide rail extends laterally along at least part of the receiving compartment.

3. The slicer according to claim 1 comprising a movable support which can be moved to support and/or push the bread to be sliced or the slices of the sliced bread.

4. The slicer according to claim 1, comprising a bagging pallet provided in the loading compartment, this pallet being movable between a receiving position in which the pallet extends in the plane of the support surface and a wrapping position in which at least one end of the pallet is raised relative to the plane of the support surface.

5. The slicer according to claim 4, wherein the bagging pallet is formed by a movable portion of the support surface.

6. The slicer according to claim 4, wherein the bagging pallet is pivot-mounted about a horizontally extending pivot axis.

7. The slicer according to claim 4, wherein the bagging pallet is pivot-mounted about a pivot axis extending in the plane of the support surface.

8. The slicer according to claim 4, having a lateral guide surface adjacent to the support surface and extending substantially transversely thereto and parallel to said direction of travel to help guide the bread as the bread moves between the compartments.

9. The slicer according to claim 8, wherein the support surface is inclined between the lateral sides at an angle (β) relative to the horizontal so that a loaf of bread which is put on the support surface rests against said guide surface.

10. The slicer according to claim 8, wherein the bagging pallet has a side flange connecting to the guide surface in the receiving position of the pallet.

11. The slicer according to claim 10, wherein the guide surface has a recess in which said lateral flange is housed extending in the extension of the guide surface when the bagging pallet is in said receiving position.

12. The slicer according to claim 10, wherein a certain distance is present between said flange and the guide surface when the pallet is in the wrapping position, to permit sliding a bag onto the pallet in order to wrap the bread.

13. A method for slicing a loaf of bread with a slicer having a frame with a front side, opposite a rear side, and two lateral sides extending between the front side and the rear side, this slicer comprising a loading compartment which is connected to a receiving compartment, the loading compartment being adjacent to said front side while the receiving compartment is close to said rear side, this method comprising the following steps:
putting a loaf of bread to be sliced in the loading compartment of the slicer by a user who is positioned in front of the front side of the slicer,
seizing the loaf by a movable push rod which is guided by a guide rail,
moving the loaf of bread towards the receiving compartment by the push rod and returning the loaf of bread to the loading compartment from the receiving compartment according to a direction of movement inclined to the horizontal and substantially parallel to said guide rail,
cutting successive slices of the loaf of bread as the loaf of bread moves downwards in the direction of movement between the compartments, the slices being cut from the bread in a cutting plane extending substantially perpendicularly to said direction of movement of the bread,
wherein the loaf of bread and the movable push rod are moved in said direction of movement inclined at an angle (α) greater than 10° and less than 25°, relative to a horizontal line which extends perpendicularly to the front side of the slicer.

14. The method according to claim 13, wherein the loaf of bread is received by a bagging pallet following the movement of the loaf of bread from the receiving compartment to the loading compartment along said direction of movement, said pallet extending substantially in said direction of movement when receiving the loaf of bread.

15. The method according to claim 14, wherein, after the bagging pallet has received the loaf of bread, the pallet is moved together with the loaf of bread relative to said direction of movement towards a wrapping position in which at least one end of the pallet is elevated relative to said direction of movement of the loaf of bread.

16. The method according to claim 14, wherein a wrapping bag is slid over the pallet and the loaf of bread as a whole from said end of the pallet, after which the bag containing the loaf of bread is removed from the pallet.

17. The slicer according to claim 1, wherein the angle (α) of the support surface is between 15° and 24°, with respect to a horizontal line extending perpendicularly to the front side of the slicer.

18. The method according to claim 13, wherein the angle (α) of the support surface is between 15° and 24°, with respect to a horizontal line extending perpendicularly to the front side of the slicer.
